(19) United States
(12) Patent Application Publication
(10) Pub. No.: US 2026/0328337 A1
(43) Pub. Date: Oct. 22, 2026

(54) MODULAR SNAP-IN COMPONENT MOUNTING SYSTEM

(71) Applicant: VenHub IP, LLC, Pasadena, CA (US)

(72) Inventors: Shoushana Ohanessian, Glendale, CA (US); Andres Munoz, West Covina, CA (US); David Leandro, Norwalk, CA (US); Stepan Cholakhyan, Glendale, CA (US); Shahan Ohanessian, Glendale, CA (US)

(21) Appl. No.: 19/650,526

(22) Filed: Apr. 17, 2026

Related U.S. Application Data
(60) Provisional application No. 63/791,979, filed on Apr. 21, 2025.

(51) Int. Cl. F16M 13/02

(52) U.S. Cl. CPC F16M 13/02

(57) ABSTRACT

A modular snap-in component mounting system enables tool-less, secure installation and controlled removal of components at desired locations on a floor surface. The system comprises a bottom housing, a bottom housing cap, and a component base. The bottom housing is a generally circular housing configured to be received within a circular floor cutout and includes two diametrically opposed solenoid latch assemblies, each having a spring-biased, pivotable latch element that automatically deploys to engage the underside of the floor surface upon insertion of the bottom housing, and that retracts upon energization of a linear pull solenoid to permit removal. The bottom housing cap is secured to the upper end of the bottom housing and presents an upward-facing magnetic ring having an annular body and radially inward-extending linear portions. The component base is affixed to the underside of a component to be mounted and presents a downward-facing magnetic ring of matching configuration. The opposing magnetic rings are magnetized with like poles facing to provide self-centering lateral alignment, and the radially extending linear portions magnetically align to establish a defined rotational orientation. Components may be supported at multiple mounting points by employing a plurality of component bases and corresponding bottom housings. The system is particularly suited to modular commercial environments such as retail facilities where rapid floor layout reconfiguration is required.

### CROSS-REFERENCE TO RELATED APPLICATIONS

This application claims priority from U.S. Provisional Patent Application No. 63/791,979 titled “Modular Snap-In Component Mounting and Power Distribution System” filed with the United States Patent and Trademark Office on Apr. 21, 2025, the specification of which is incorporated herein by reference in its entirety.

### FIELD OF THE INVENTION

This invention relates generally to modular component mounting systems, and more particularly to a snap-in mounting system that enables tool-less, secure installation of components onto a floor surface through the use of spring-biased solenoid latches and a magnetic alignment interface, with the capability to be selectively released and repositioned as needed.

### BACKGROUND OF THE INVENTION

Component mounting systems are widely used across commercial and industrial environments to position and secure equipment, display units, shelving, refrigeration units, and other components at desired locations on a floor surface. Conventional approaches to floor-mounting such components typically require mechanical fasteners such as bolts, screws, or anchors that penetrate the floor surface, adhesives, or other permanent or semi-permanent attachment means. These methods require tools, create installation complexity, and render repositioning difficult, time-consuming, and potentially damaging to the floor surface.

In modular commercial environments such as retail stores, warehouses, and manufacturing facilities, the ability to reconfigure floor layouts quickly and efficiently has significant operational value. Components must often be relocated as product offerings change, floor plans are updated, or operational needs evolve. Conventional floor-mounting systems are poorly suited to these demands because disassembly requires tools and labor, and repeated installation and removal can damage both the component and the floor.

Existing snap-fit or magnetic mounting approaches, while offering some degree of tool-less installation, generally lack the ability to provide secure, locked engagement that prevents unintended dislodgement of heavy or mechanized equipment during operation. They also typically do not provide a reliable means of precise rotational and positional alignment between the mounted component and the floor-mounted interface.

A need therefore exists for a component mounting system that enables rapid, tool-less installation onto a floor surface; that provides secure, locked engagement sufficient to prevent unintended removal during operation; that allows for precise positional and rotational alignment of the mounted component; and that permits selective, controlled release and repositioning of the component as needed.

### SUMMARY OF THE INVENTION

In accordance with certain aspects of a preferred embodiment, a modular snap-in component mounting system is provided that addresses these shortcomings by enabling rapid, tool-less installation onto a floor surface, automatic locked engagement upon insertion, precise self-centering and rotational alignment, and selective controlled release for repositioning. The system comprises three principal elements: a bottom housing, a bottom housing cap, and a component base. The bottom housing is configured to be received within a circular cutout formed in the floor surface and incorporates spring-biased solenoid latch assemblies that automatically deploy to engage the underside of the floor upon insertion of the bottom housing, thereby locking it in place without any separate fastening step. The bottom housing cap is secured to the upper end of the bottom housing and presents an upward-facing magnetic ring having an annular body and radially extending linear portions. The component base is affixed to the underside of the component to be mounted and presents a downward-facing magnetic ring of matching configuration. When the component is lowered onto the bottom housing cap, the opposing magnetic rings, magnetized with like poles facing one another, interact to provide automatic self-centering lateral alignment, and the radially extending linear portions of the two rings magnetically interlock to establish a precise and consistent rotational orientation of the component relative to the floor without manual adjustment. Solenoid actuation retracts the latch elements to permit removal and repositioning of the bottom housing as needed. Where greater support is required, a plurality of component bases may be affixed to the underside of a single component, each engaging a corresponding bottom housing, to distribute load across multiple mounting points.

The system provides significant advantages over existing mounting solutions, including fully tool-less installation and removal, automatic locking engagement that secures heavy and mechanized components against unintended dislodgement during operation, self-centering and rotationally self-aligning mounting that eliminates manual positioning adjustments, and rapid reconfigurability of floor layouts without damage to the floor surface. These characteristics make the system particularly well-suited to modular commercial environments, such as retail facilities, where floor configurations must be updated frequently and efficiently.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a perspective view of a modular snap-in component mounting system according to certain aspects of an embodiment of the invention.

FIG. 1(a) is a perspective view of the bottom housing of the system of FIG. 1 with the interior shown open to illustrate the solenoid latch assemblies positioned within the bottom housing.

FIG. 2 is a top perspective view of the bottom housing cap of the system of FIG. 1 showing the upward-facing magnetic ring with radially extending linear portions.

FIG. 3 is a bottom view of the component base of the system of FIG. 1 showing the downward-facing magnetic ring with radially extending linear portions, configured to magnetically engage the upward-facing magnetic ring of the bottom housing cap.

FIG. 4 is a perspective view of a mechanized component in the form of a bagging or delivery device integrated onto a floor panel, wherein four component bases are mounted to an underside of the component and engage with corresponding bottom housings installed in the floor panel.

FIG. 5 is a front view of the mechanized component integrated onto the floor panel of FIG. 4, showing the bottom housings positioned at the underside of the floor panel.

FIG. 6 is a top cross-sectional view of the mechanized component integrated onto the floor panel of FIGS. 4 and 5, taken along section line A-A of FIG. 4.

FIG. 7 is a perspective view of a shelving unit component integrated onto a floor panel, wherein four component bases are mounted to an underside of the shelving unit and engage with corresponding bottom housings installed in the floor panel.

FIG. 8 is a front view of the shelving unit integrated onto the floor panel of FIG. 7, showing the bottom housings at the underside of the floor panel.

FIG. 9 is a top cross-sectional view of the shelving unit integrated onto the floor panel of FIGS. 7 and 8, taken along section line B-B of FIG. 8.

FIG. 10 is a perspective view of a refrigerator unit component integrated onto a floor panel, wherein six component bases are mounted to an underside of the refrigerator unit and engage with corresponding bottom housings installed in the floor panel.

FIG. 11 is a front view of the refrigerator unit component integrated onto the floor panel of FIG. 10, showing the bottom housings at the underside of the floor panel.

FIG. 12 is a side cross-sectional view of the refrigerator unit component integrated onto the floor panel of FIGS. 10 and 11, taken along section line C-C of FIG. 11.

FIG. 13 is a detail side view of a component base on the underside of the refrigerator unit of FIGS. 10–12, shown installed on a bottom housing positioned in the floor panel.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

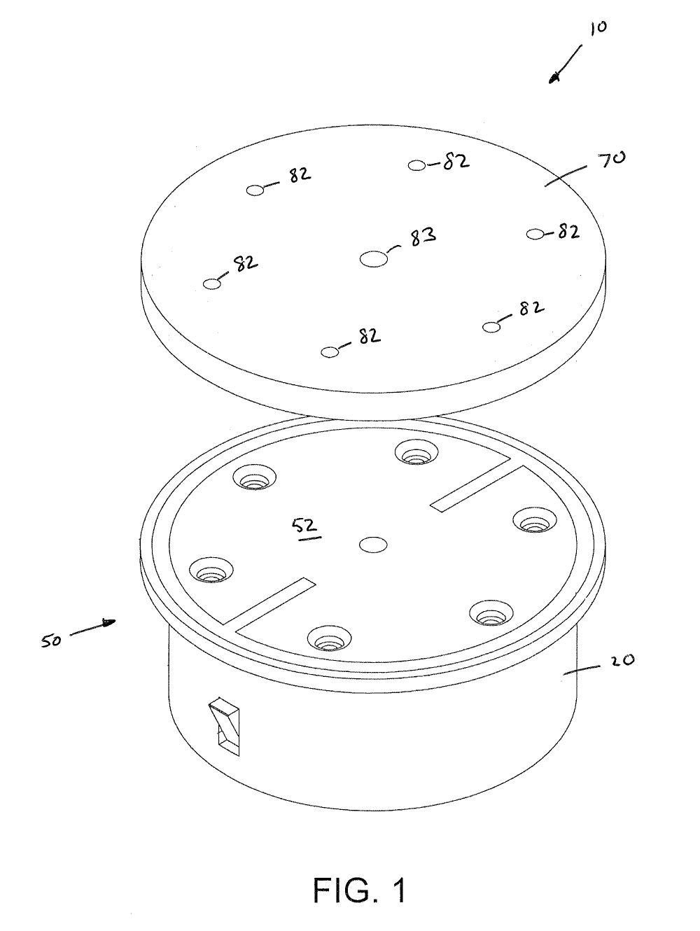

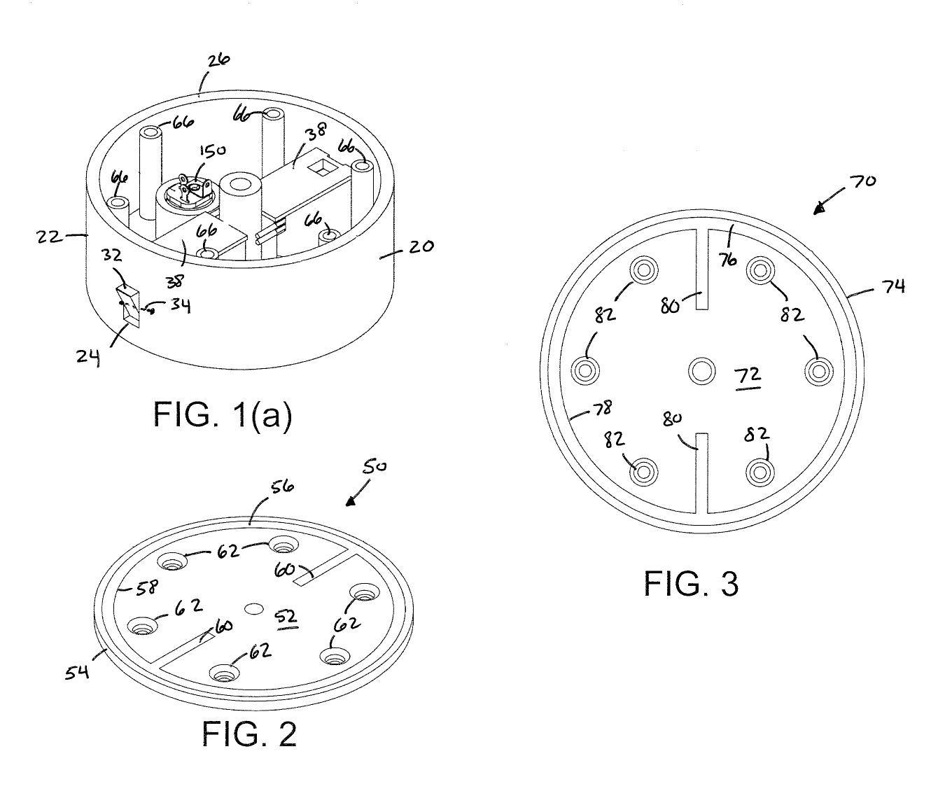

Referring first to FIG. 1, the bottom housing 20 is a generally circular housing configured to be received within a corresponding circular floor cutout 92 formed through the surface of a floor 90. In exemplary embodiments, the bottom housing 20 has an overall diameter of approximately three to six inches and a height of approximately one to three inches, with the floor cutout 92 dimensioned to closely match the outer diameter of the bottom housing 20 so as to permit insertion and removal of the bottom housing 20 while providing a sufficiently close fit to resist rotation of the bottom housing 20 within the cutout 92, primarily through friction. In alternative embodiments, the bottom housing 20 may additionally be secured against rotation or axial displacement within the cutout 92 by adhesive, set screws, or other fastening means applied between the outer surface of the circumferential wall 22 of the bottom housing 20 and the interior wall of the floor cutout 92.

The bottom housing 20 contains two solenoid latch assemblies, each mounted within the interior of the bottom housing 20 and positioned at diametrically opposed locations, i.e., spaced 180° apart around the circumference of the bottom housing 20. Each solenoid latch assembly includes a latch element 32 that extends outwardly through an opening 24 in the circumferential wall 22 of the bottom housing 20. In a preferred exemplary configuration, the latch element 32 comprises a generally triangular block that is pivotably mounted within the bottom housing 20 by a pivot pin 34 extending through a lower portion of the latch element 32. The pivot pin 34 permits the latch element 32 to pivot between an outwardly extended, deployed position and a retracted position in which the latch element 32 is drawn inward into the circumferential wall 22 of the bottom housing 20. When the latch element 32 is in the deployed position, a top face of the triangular latch element 32 is oriented generally horizontally and is positioned at or immediately adjacent to the underside surface 94 of the floor 90 immediately surrounding the cutout 92, engaging that underside surface 94 to prevent the bottom housing 20 from being withdrawn upwardly out of the floor cutout 92. In exemplary configurations, the top face of the latch element 32 in the deployed position is positioned so as to either directly contact the underside surface 94 of the floor 90 or to be positioned no more than approximately one-quarter inch below the underside surface 94, thereby providing secure engagement against upward withdrawal while accommodating minor variations in floor thickness.

Each solenoid latch assembly further includes a spring member (not shown) that biases the latch element 32 toward the deployed, outwardly extended position. A connecting arm extends between the solenoid 38 and an interior portion of the latch element 32 such that, when the solenoid 38 is energized, it draws the connecting arm inward, thereby pivoting the latch element 32 about the pivot pin 34 and retracting the latch element 32 into the circumferential wall 22 of the bottom housing 20. Conversely, when the solenoid 38 is de-energized, the spring member urges the connecting arm and latch element 32 back to the deployed position. In an alternative embodiment, the spring member and solenoid 38 may be arranged in a complementary configuration such that the latch elements 32 are spring-biased inward and solenoid actuation urges the latch elements 32 outward, thereby locking the bottom housing 20 in the floor cutout 92 upon energization of the solenoid 38 rather than upon de-energization. Those skilled in the art will recognize that either arrangement falls within the scope of the present invention.

The solenoids 38 used in the latch assemblies are preferably linear pull solenoids, wherein energization of the solenoid 38 generates a linear pulling force along the axis of the connecting arm. The stroke length of each solenoid 38, meaning the distance over which the connecting arm travels during actuation, is sufficient to draw the latch element 32 entirely within the circumferential boundary of the bottom housing 20, and in exemplary embodiments is approximately one-quarter to one inch. Electrical power to operate the solenoids 38 is preferably provided from an external source through the floor structure to the bottom housing 20, for example through a barrel-type power connector 150 within the bottom housing 20. A battery-based backup power supply 152 may additionally be housed within the bottom housing 20 to provide continued operability of the solenoids 38 in the event of an external power failure.

Actuation of the solenoids 38 to release the bottom housing 20 from the floor cutout 92 is controlled through a switch 160 that is in electrical communication with the power supply to each solenoid 38. In one embodiment, the switch 160 is a manually operated wall switch located at a convenient position within the facility or unit in which the mounting system 10 is installed. In an alternative embodiment, a wireless switch or wireless control interface serves as the switch 160 to enable remote activation of the solenoids 38 without the need for a dedicated hardwired switch, offering greater flexibility in installation configurations.

Turning now to FIG. 2, the bottom housing cap 50 is a generally disc-shaped element that is secured to the upper end 26 of the bottom housing 20 and presents an upward-facing surface 52 on which the component base 70 rests when a component is mounted. The bottom housing cap 50 has an outer diameter that is approximately one-quarter to one inch greater than the outer diameter of the bottom housing 20, such that the cap 50 overhangs the upper rim of the bottom housing 20 and provides a seating surface of defined outer dimension. The bottom housing cap 50 has a thickness of approximately one-eighth to one-quarter inch. The cap 50 is secured to the upper end 26 of the bottom housing 20 by threaded fasteners, for example screws, that extend downwardly through fastener openings 62 formed in the face of the cap 50 and are received in corresponding threaded receivers 66 located inside the upper end 26 of the bottom housing 20. In exemplary embodiments, six such fastener openings 62 are provided, arranged in a circular pattern set inwardly approximately one-half inch from the outer circumferential rim 54 of the bottom housing cap 50. Alternative attachment means, such as snap-fit features, adhesive, or other fasteners, may also be used.

The upward-facing surface 52 of the bottom housing cap 50 carries a first magnetic ring 56 positioned just inward of and in contact with the outer circumferential rim 54 of the cap 50. The first magnetic ring 56 has a radial width of approximately one-quarter inch and a thickness of approximately one-eighth to one-quarter inch. The first magnetic ring 56 is secured to the cap 50 by adhesive, press fit, or equivalent retention means. The first magnetic ring 56 comprises an annular body 58 and two radially extending linear portions 60 that extend radially inward from the annular body 58 and are spaced 180° apart from one another. The radially extending linear portions 60 are formed continuously with and as part of the annular body 58 of the first magnetic ring 56, have the same thickness as the annular body 58, and lie coplanar with the upward-facing surface 52 of the cap 50. In exemplary embodiments, the width of each linear portion 60 is equal to the radial width of the annular body 58 of the first magnetic ring 56. The linear portions 60 extend radially inward from the inner edge of the annular body 58 by a distance sufficient to provide the rotational alignment function described below, with the specific length being readily determinable by those skilled in the art based on the overall dimensions of the system 10.

Referring now to FIG. 3, the component base 70 is a generally disc-shaped element that is affixed to the underside of a component to be mounted. The component base 70 has an outer diameter generally equal to the outer diameter of the bottom housing cap 50, such that the downward-facing surface 72 of the component base 70 and the upward-facing surface 52 of the bottom housing cap 50 are substantially flush in dimension when the component is mounted. The component base 70 has a height of approximately one-quarter to two inches. The component base 70 is affixed to the underside of the component by threaded fasteners, such as screws, that extend through fastener opening 83 formed in the body of the component base 70 and are received in the bottom structure of the component. Likewise, fastener openings 82 in the component base 70 are preferably sized equally to the fastener openings 62 in the bottom housing cap 50, and may receive threaded fasteners for fixed attachment of component base 70 to bottom housing cap 50 when a more permanent attachment is desired. The fastener openings 82 may be threaded to receive fasteners directly or may be smooth bores requiring separate nuts or inserts, depending on the application.

The downward-facing surface 72 of the component base 70 carries a second magnetic ring 76 that mirrors the first magnetic ring 56 of the bottom housing cap 50 in all respects. The second magnetic ring 76 is positioned just inward of and in contact with the outer circumferential rim 74 of the component base 70, has the same radial width and thickness as the first magnetic ring 56, is secured by adhesive or press fit, and comprises an annular body 78 and two radially extending linear portions 80 that are continuous with the annular body 78, spaced 180° apart, coplanar with the downward-facing surface 72 of the component base 70, and equal in width to the radial width of the annular body 78. The magnetic poles of the two opposing rings, namely the upward-facing first magnetic ring 56 on the cap 50 and the downward-facing second magnetic ring 76 on the component base 70, are oriented so that like poles face one another, producing a repulsive magnetic interaction that functions to center and align the component base 70 on the cap 50 in both the lateral and rotational dimensions. When the component base 70 is brought into proximity with the bottom housing cap 50, the opposing first and second magnetic rings 56, 76 provide a self-centering force that draws the component base 70 into precise lateral alignment. The two pairs of radially extending linear portions, namely the linear portions 60 on the first magnetic ring 56 and the linear portions 80 on the second magnetic ring 76, are dimensioned identically and, by virtue of the magnetic interaction of the rings 56, 76, align with one another to create a magnetic interlock that establishes and maintains a defined rotational orientation of the component base 70 relative to the bottom housing cap 50. This magnetic interlock is achieved through magnetic interaction rather than mechanical engagement, meaning that the linear portions 60, 80 do not physically interlock but instead magnetically favor the aligned rotational position, providing smooth self-alignment during installation while resisting subsequent rotational displacement.

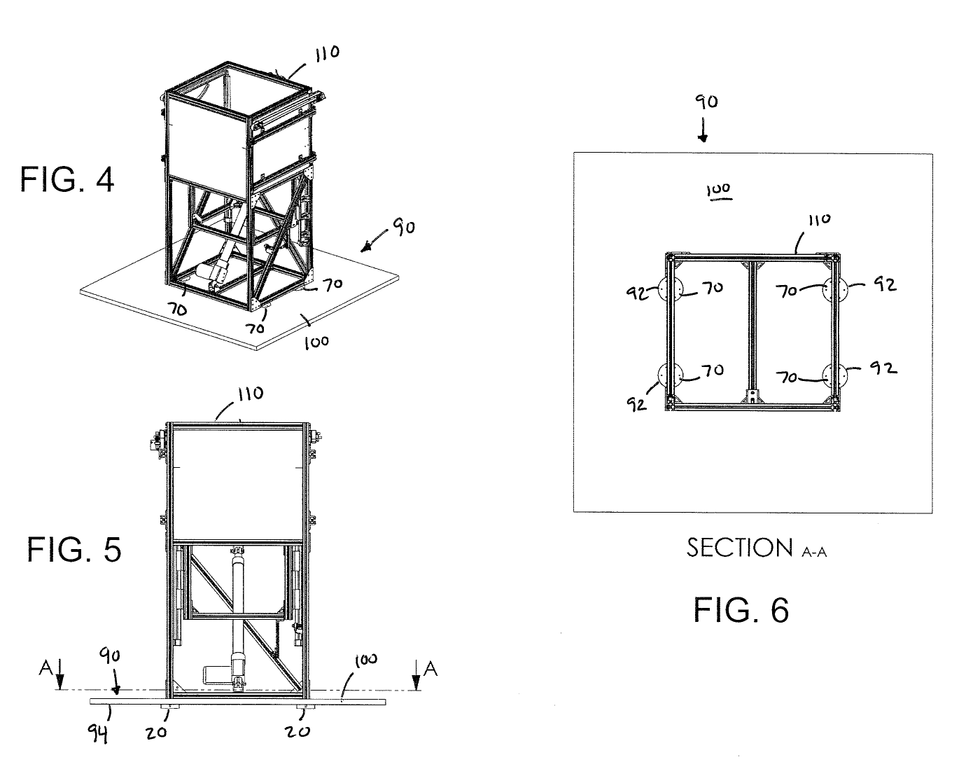

The operation of the complete mounting system 10 is as follows. To prepare a mounting location, a circular floor cutout 92 of dimensions matching the outer diameter of the bottom housing 20 is formed or provided at the desired location in the floor surface 90. The bottom housing 20 is then inserted downwardly into the floor cutout 92. As the bottom housing 20 is pushed into the cutout 92, the inclined outer faces of the latch elements 32 contact the edge of the cutout 92, causing the latch elements 32 to cam inward and retract into the circumferential wall 22 of the bottom housing 20 against the bias of the spring members. Once the bottom housing 20 is fully inserted to the appropriate depth, the latch elements 32 pass below the underside surface 94 of the floor 90 and the spring members urge them back outward to the deployed position, placing the top faces of the latch elements 32 against or immediately adjacent to the underside surface 94 of the floor 90. The bottom housing 20 is thereby secured within the floor cutout 92 and prevented from being withdrawn without solenoid actuation. The component, with one or more component bases 70 pre-affixed to its underside, is then positioned above the bottom housing 20 or housings and lowered into place. The opposing first and second magnetic rings 56, 76 on the cap 50 and component base 70 engage as the component is brought into proximity, providing self-centering and rotational alignment, and the component settles into its mounted position on the bottom housing cap 50. Optionally, component base 70 may then be affixed to bottom housing 20 and bottom housing cap 50 using threaded fasteners. The mounted configuration is illustrated for three representative component types in FIGS. 4-13, discussed further below.

To reposition or remove the bottom housing 20 from a floor cutout 92, the solenoids 38 are actuated by operating the associated switch 160, which energizes the solenoids 38 and causes each solenoid’s connecting arm to draw the corresponding latch element 32 inward and retract it within the circumferential wall 22 of the bottom housing 20. With the latch elements 32 retracted, the bottom housing 20 is freed from engagement with the underside surface 94 of the floor 90 and may be withdrawn upwardly from the floor cutout 92. Upon de-energization of the solenoids 38, the spring members return the latch elements 32 to the deployed position. Separately, the component may be lifted away from the bottom housing cap 50 at any time, as the magnetic coupling between the component base 70 and the cap 50, while providing alignment and retention under normal operating conditions, is overcome by a sufficient upward lifting force without requiring solenoid actuation.

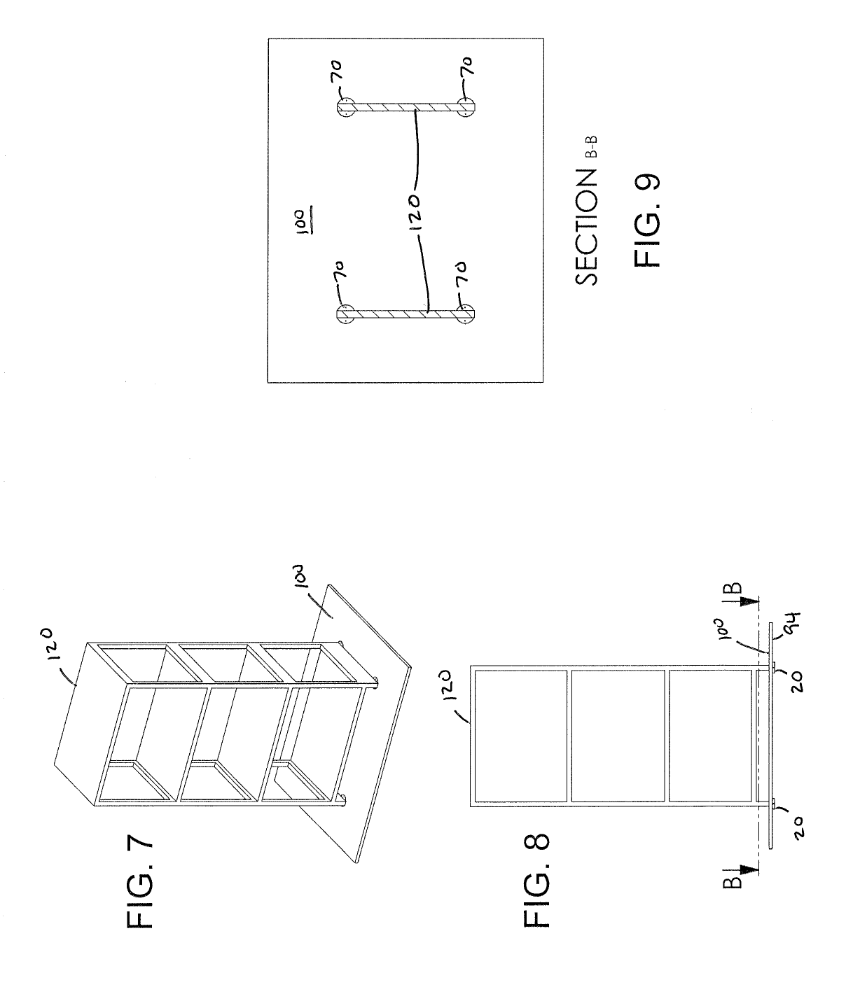

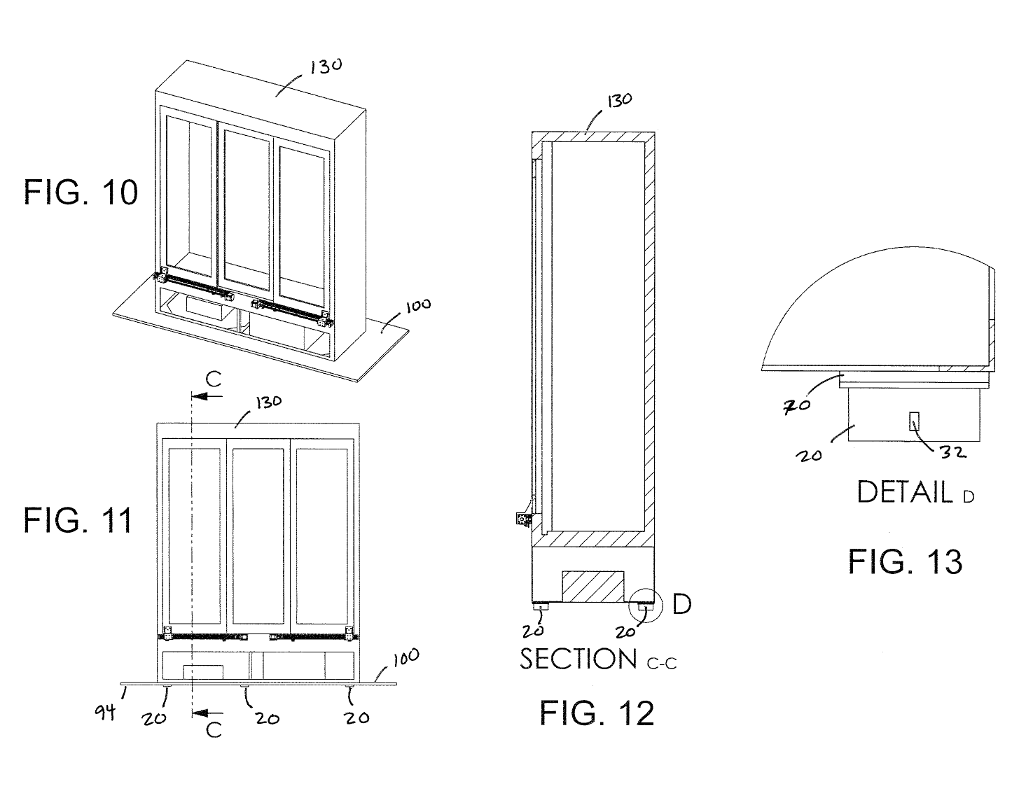

The modular snap-in component mounting system 10 of the present invention is particularly well-suited for use in modular commercial and retail environments where floor layouts must be periodically reconfigured. Three representative applications are illustrated in FIGS. 4-13. In a first application shown in FIGS. 4-6, a mechanized delivery or bagging device 110 is mounted on a floor panel 100 using four mounting points, each comprising a component base 70 on the underside of the device 110 engaged with a corresponding bottom housing 20 installed in the floor panel 100. In a second application shown in FIGS. 7-9, a shelving unit 120 is mounted on a floor panel 100 using four mounting points in the same manner. In a third application shown in FIGS. 10-13, a refrigerator unit 130 is mounted on a floor panel 100 using six mounting points, providing the additional support appropriate for the greater size and weight of the refrigeration unit 130. In each application, the component is rapidly and precisely positioned on the floor panel 100 through the self-centering and rotationally aligning action of the first and second magnetic rings 56, 76, and the bottom housings 20 are locked in the floor panel 100 by the spring-biased solenoid latch assemblies until intentional release is desired. FIG. 13 provides a detail view of the engagement between a component base 70 and a bottom housing 20 as installed in the floor panel 100.

The number of mounting points used for any given component is not limited to the embodiments illustrated but may be selected based on the size, weight, and stability requirements of the component. Similarly, while the illustrated embodiments show use of a floor panel 100 configured to receive multiple bottom housings 20 at defined locations, the system 10 is not limited to use with any particular type of floor structure and may be deployed in any floor surface 90 in which appropriate circular cutouts 92 can be formed.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

What is claimed is:

1. A modular snap-in component mounting system comprising:
a bottom housing having a generally circular cross-section configured to be received within a corresponding circular floor cutout, the bottom housing comprising at least two solenoid latch assemblies, each solenoid latch assembly comprising a latch element movable between a deployed position in which the latch element extends outwardly through an opening in a circumferential wall of the bottom housing and a retracted position in which the latch element is withdrawn within the circumferential wall of the bottom housing, a spring member biasing the latch element toward the deployed position, and a solenoid operably connected to the latch element such that energization of the solenoid drives the latch element toward the retracted position against the bias of the spring member, wherein the latch element in the deployed position presents a generally horizontal surface configured to engage an underside of a floor surface surrounding the floor cutout to resist withdrawal of the bottom housing from the floor cutout;
a bottom housing cap secured to an upper end of the bottom housing, the bottom housing cap having an upward-facing surface carrying a first magnetic ring, the first magnetic ring comprising an annular body and at least two linear portions extending radially inward from the annular body; and
a component base configured to be affixed to an underside of a component, the component base having a downward-facing surface carrying a second magnetic ring, the second magnetic ring comprising an annular body and at least two linear portions extending radially inward from the annular body, the second magnetic ring configured to oppose the first magnetic ring when the component base is placed on the bottom housing cap, wherein the first and second magnetic rings are magnetized with like poles facing one another to provide a self-centering magnetic interaction between the bottom housing cap and the component base, and wherein the linear portions of the first and second magnetic rings are configured to magnetically align with one another to define a preferred rotational orientation of the component base relative to the bottom housing cap.

2. The system of claim 1, wherein the at least two solenoid latch assemblies are positioned at diametrically opposed locations around a circumference of the bottom housing.

3. The system of claim 1, wherein each latch element comprises a generally triangular block pivotably mounted within the bottom housing by a pivot pin.

4. The system of claim 3, wherein a connecting arm connects the solenoid to an interior portion of the latch element such that energization of the solenoid draws the connecting arm to pivot the latch element about the pivot pin toward the retracted position, and de-energization of the solenoid permits the spring member to return the latch element to the deployed position.

5. The system of claim 1, wherein each solenoid is a linear pull solenoid.

6. The system of claim 1, wherein the solenoid latch assemblies are actuated by a switch in electrical communication with a power supply to the solenoids of the solenoid latch assemblies, the switch comprising at least one of a manually operated wall switch and a wireless switch.

7. The system of claim 1, wherein a battery-based backup power supply is housed within the bottom housing to provide power to the solenoid latch assemblies in the event of an external power failure.

8. The system of claim 1, wherein the first magnetic ring is disposed adjacent to an outer circumferential rim of the bottom housing cap, and the second magnetic ring is disposed adjacent to an outer circumferential rim of the component base.

9. The system of claim 1, wherein the at least two linear portions of each of the first and second magnetic rings comprise two linear portions spaced 180° apart, each linear portion being coplanar with the face of the annular body of the respective magnetic ring.

10. The system of claim 1, wherein the bottom housing cap is secured to the bottom housing by a plurality of threaded fasteners extending through the bottom housing cap and received in receivers within the upper end of the bottom housing.

11. The system of claim 1, wherein the component base is affixed to the underside of the component by threaded fasteners extending through the component base.

12. The system of claim 1, wherein a plurality of component bases are affixed to an underside of the component, each component base configured to engage a corresponding bottom housing, whereby the component is supported at a plurality of mounting points.

13. A bottom housing assembly for use in a floor-mounted component mounting system, comprising:
a generally circular housing configured to be received within a corresponding circular floor cutout, the housing having a circumferential wall with at least two openings;
at least two solenoid latch assemblies housed within the housing, each solenoid latch assembly comprising a latch element movable between a deployed position in which the latch element extends outwardly through one of the openings to present a generally horizontal surface for engaging an underside of a floor surface surrounding the floor cutout, and a retracted position in which the latch element is withdrawn within the circumferential wall, a spring member biasing the latch element toward the deployed position, and a solenoid operably connected to the latch element, wherein energization of the solenoid drives the latch element toward the retracted position against the bias of the spring member; and
a power connection for supplying electrical power to the solenoid latch assemblies.

14. The bottom housing assembly of claim 13, wherein the at least two solenoid latch assemblies are positioned at diametrically opposed locations around a circumference of the housing.

15. The bottom housing assembly of claim 13, wherein each latch element comprises a generally triangular block pivotably mounted within the housing by a pivot pin.

16. The bottom housing assembly of claim 15, wherein a connecting arm connects the solenoid to an interior portion of the latch element such that energization of the solenoid draws the connecting arm to pivot the latch element about the pivot pin toward the retracted position.

17. The bottom housing assembly of claim 13, wherein each solenoid is a linear pull solenoid.

18. The bottom housing assembly of claim 13, wherein the power connection comprises a barrel-type connector for receiving external power, and wherein the housing further contains a battery-based backup power supply for supplying power to the solenoid latch assemblies in the event of an external power failure.

19. A method of mounting a component to a floor surface using a modular snap-in mounting system, the method comprising:
providing a circular floor cutout in a floor surface at a desired mounting location;
inserting a bottom housing into the floor cutout, wherein latch elements of solenoid latch assemblies within the bottom housing retract inwardly during insertion as they contact an edge of the floor cutout, and automatically return to a deployed position upon full insertion, wherein the latch elements in the deployed position engage an underside of the floor surface surrounding the floor cutout to resist withdrawal of the bottom housing from the floor cutout;
placing a component having at least one component base affixed to its underside onto a bottom housing cap secured to an upper end of the bottom housing, wherein a magnetic ring on the component base opposes a magnetic ring on the bottom housing cap, the opposing magnetic rings having like poles facing one another to provide a self-centering interaction that laterally and rotationally aligns the component base on the bottom housing cap; and
selectively removing the bottom housing from the floor cutout by energizing solenoids of the solenoid latch assemblies to drive the latch elements to a retracted position, thereby freeing the bottom housing for withdrawal from the floor cutout.

20. The method of claim 19, wherein placing the component comprises positioning the component over a plurality of bottom housings such that a corresponding plurality of component bases each engage a respective bottom housing cap, the component thereby being supported at a plurality of mounting points.
